(19) United States
(12) Patent Application Publication
(10) Pub. No.: US 2007/0214208 A1
(43) Pub. Date: Sep. 13, 2007

(54) Business Process Externalization Execution Platform, System and Method

(76) Inventor: Bobby Balachandran, Wilsonville, OR (US)

Correspondence Address: PETER A. HAAS, ESQUIRE, 1929 SW 13TH AVENUE, PORTLAND, OR, 97201, US

(21) Appl. No.: 11/682,723

(22) Filed: Mar. 6, 2007

Related U.S. Application Data
(60) Provisional application No. 60/779,727, filed on Mar. 7, 2006.

(51) Int. Cl. G06F 15/16

(52) U.S. Cl. 709/201

(57) ABSTRACT

The present invention includes a system, method, and software-platform whereby business services are orchestrated to create a holistic solution where each business service is provisioned to a network of rated service providers. The invention includes a method that effectively productizes business services and sells them as on-line commodities.

### PRIORITY CLAIM

This application claims benefit for all purposes to U.S. Provisional Patent Application No. 60/779,727 filed on 07 Mar. 2006 by the common inventor Bobby Balachandran.

### BACKGROUND

1. Field of the Invention.

The present invention relates generally to on-line services and, more particularly, to methods, systems, and software for outsourcing business services to a plurality of world-wide service providers.

2. Discussion of Background.

Today's global economy creates an ever-increasing demand on companies of all sizes to eliminate inefficiencies, reduce wasted effort, and otherwise trim operating costs without sacrificing quality and service. Large, multi-national organizations utilize economies of their scale to leverage inexpensive labor dependant only upon the nature of the task without concern of national boundaries. Smaller organizations, however, are unable to justify multi-national operations presence, and therefore they forgo cost-savings related to international labor rates, task specialization, or sheer volume of scale.

Despite these barriers to cost-effective globalization, many small companies and start-up companies require outsourced services. For example, currently many companies out-source accounting services, payroll, tax-preparation, legal services, and marketing. However, there is a lack of a scalable systems-solution to outsourcing. In addition, there is a lack of a systems-solution that appeals to the locations, solicitation, and retention of service providers on a global scale.

United States Patent Application Publication No. US 2005/0091093 to Bhaskaran et al. and published on 28 Apr. 2005 attempts to provide an end-to-end-business process solution. This reference describes a system and method for creating and managing a business process integration solution by modeling a business strategy including elements representing business measurements and initiatives according to defined goals and objectives of an entity, modeling business-process elements, mapping elements, and measuring performance compared to key performance indicators. This reference, however, does not describe a method for orchestrating external business services to create a holistic solution from a network of global service providers.

United States Patent Application Publication No. US 2005/0197970 by Chehade et al. and published on 08 Sep. 2005 describes a system and method for workflow-enabled link activation including a system for networked-based, workflow-enabled project management allowing trade gateways between a business entity and one or more trading partners. This reference describes computer networks-based interfaces to assess stages of planning and readiness of partners, implementing the trade gateways, testing the gateways, and migrating the gateways to production. This reference, however, does not describe a system and method for orchestrating external business services to create a holistic solution from a network of global service providers.

United States Patent Application Publication No. US 2005/0267822, by Mead and published on 01 Dec. 2005 describes a system and method for outsourced supplier management. This reference attempts to improve order-communication between customers, sellers, and outsourced suppliers. This reference is limited to the supply-management chain in an organization and, moreover, this reference does not describe a system and method for orchestrating external business services to create a holistic solution from a network of global service providers.

United States Patent Application Publication No. US 2003/0040920 by Adams et al. and published on 27 Feb. 2003 attempts to describe architecture-design, a method, and system for an e-business solution involving a business description of each actor and function in the e-business solution. This reference describes pictorially representing a business description by identifying business patterns, integration patterns, composite patterns, and application patterns. This reference, however, does not describe a system and method for orchestrating external business services to create a holistic solution from a network of global service providers.

United States Patent Application Publication No. US 2003/0028419 by Monaghan and published on 06 Feb. 2003 describes a system and method for providing website business solutions to client via the Internet. This reference describes a system and method for delivering specialized business solutions including six stages: a business analysis phase wherein a strategy is established; a functional design phase for developing a website; a building phase for coding and a database integration; a testing phase; a launch phase; and a managing phase. This reference is limited to web-development and, moreover, does not describe a system and method for orchestrating external business services to create a holistic solution from a network of global service providers.

United States Patent Application Publication No. US 2003/0225638 by Secola and published on 04 Dec. 2003 describes a method for outsourcing accounting functions. This reference is limited to accounting services and, moreover, does not describe a system and method for orchestrating external business services to create a holistic solution from a network of global service providers.

Despite recent attempts for methods and systems to integrate outsourced business solutions there is a lack of an integrated solution for orchestrating external business services to create a holistic solution from a network of global service providers.

### SUMMARY OF THE INVENTION

The present invention solves problems inadequately addressed in the prior-art. In one exemplary embodiment, the present invention provides an integrated software and hardware solution that orchestrates disparate business processes executed by different service providers into one holistic, efficient, transparent Business Service Product, provisioned through a network of trusted, world-class providers from anywhere in the flat world.

Objectives of the present invention include:
1. Providing a system and method for a generic platform that partitions business services into “atomic” units or commodities that are broken down into as small a unit of measure as practicable. This commoditizing of any given business service into smaller tasks, outsourcing of non-core business activities are possible via world-wide-web (Internet) distribution to a single or to a myriad of potential service providers on a scale never-before possible; Moreover, this distribution over the web is performed with a host-based software system that does not require specialized software to reside on any computers and instead relies solely on readily available Internet browsers and standard Internet connection protocols.
2. Providing a system and method for combining disparate business services executed by different service providers into one holistic business solution which is very useful for organizations. It's efficient for organizations to outsource a complete business solution rather than just outsourcing individual business services. Moreover these individual business services can be executed (provided) by one or many service providers anywhere in the world, providing unparalleled economies of scale.
3. Facilitating the commoditizing of and subsequent transactions related to disparate outsourced business processes.
4. Enabling execution of commoditized outsourced processes and enabling execution of those processes by different vendors an integrated, holistic, efficient, and transparent “Business Service Product”. This product can then be transacted through a network of trusted, world-class service providers from anywhere in the world.
5. Enabling, by technology, the standardization and productization of business services so they can be sold and bought online just like any other consumer product.
6. Managing multiple, disparate business services executed by different service providers. The services are combined into one a logical business solution. Novel, technology-based tools manage the orchestration, management, and flow of work between different service providers.
7. Providing a software-platform incorporating a system and method for commoditizing business services. This platform, built generically, quickly adapts to new applications and can be applied to different business verticals through adaptive customization and extension.
8. Providing a system and method that radically improves organizational outsourcing of (non-core) business processes.
9. Providing a system and method that enables building and hosting innovative and technologically fresh, Internet-ready software-systems and services. Client companies can use these systems and methods in an on-demand manner without purchasing and installing costly software programs.
10. Providing innovative services (business services are productized and sold online) to organizations (of all sizes) enabling business organizations to focus in the areas where they are strong at (core-competencies) and leave the job of building the scalable platform to the methods and systems of the present invention, which enables outsourcing.
11. Providing on-demand license contracts.
12. Providing systems and methods that enable varying business loads efficiently. For example, at peak-demand times, contracted service-providers, typically, cannot deliver all the work on time. The systems and methods of the present invention (“Platform Solutions”) divide the client orders into manageable units of work and route the units to rated service providers (“bizExecutors”). The service providers may be located globally. This globalization and order-dividing enables unparalleled scalability and seamless re-integration to maximize efficiency and provide on-time services according to client budgets and other constraints.
13. Providing systems and methods to develop a platform—not to directly deliver outsourced services but, rather—to build systems and structure that enables seamless orchestration of the process of outsourcing, commoditizing, execution, and re-integration.
14. Providing a scalable system that enables flexibility to add or remove service-providers according to demand. The present invention enables the ability to add hundreds of thousands of service providers from all over the world. Each service provider can provide services for multiple client-businesses.
15. Providing a system and method that is easily duplicated for a plurality of businesses, simultaneously, without the overhead associated with maintaining a large number of employees. This also provides an extremely high-margin business model.
16. Providing a system and method which selects the most suitable business process executors worldwide intelligently rough algorithms, based on multiple parameters.

Other benefits of the present invention include:
1. Smart Process Integration Appliances that integrate with specific Enterprise Systems and effectively extract information to be outsourced to the right service provider through a software system and brings the information back to the Enterprise System
2. Smart Process Outsourcing Devices that directly send the information to be outsourced, improving efficiency and eliminating errors.
3. Manual and Automated Process Weaving that combine automated and manual business processes as complete business solutions for customers.

One exemplary use of this invention includes providing solutions for companies that want to outsource, but have difficulties implementing outsourcing due to:
1. An inability to select the best and most suitable service provider;
2. An inability to compare and shop for Service Providers in a flat world based on cost, quality, maturity, etc.;
3. An inability to efficiently manage overhead associated with switching and maintaining new service provider relationships;
4. Ambiguous requirement specifications for the business services desired and metrics for the service provider to achieve;
5. Inefficiencies in managing multiple service providers for executing one logical business process;
6. An inability to monitor service statuses and act on it in a timely manner;
7. Fluctuations in pricing;
8. Ignorance of existence of service providers for certain business services;
9. An inability to outsource and inefficiencies in outsourcing due to the lack of proper technology and security concerns;
10. An inability to handle spikes in business needs with their current service providers;
11. Costly and inefficient multilevel subcontracting activities;
12. A lack of dedicated employees to manage their outsourced business services; and
13. An inefficient middle-man network trying to manage relationships and increasing the customer cost of outsourcing.

The present invention also provides solutions to service providers having capacity to provide world-class services, but lack exposure to potential customers. Specifically, the service providers have:
1. Inefficiencies in receiving timely payments for services provided;
2. Costly sales and marketing—especially when attempting to reach a global base of customers;
3. Difficulty updating and maintaining efficient technology to interact with customers and other service providers;
4. A lack of tools that enable integration technologies to service certain business processes; and
5. Inefficient third parties (middle-men) trying to manage relationships thereby reducing service provider's margins.

### DRAWING

FIG. 1 is a block diagram illustrating a macro-view of systems and methods according to one embodiment of the present invention.

FIG. 2 is a schematic block diagram illustrating the breakdown of an outsource-ready process into smaller components and atomic tasks.

FIG. 3 is a schematic block diagram illustrating the re-integration of the components and tasks of FIG. 2.

FIG. 4 is a schematic block diagram illustrating a second embodiment according to the present invention illustrating a service task divided into atomic units of finite work elements.

FIG. 5 is a schematic block diagram detailing one node of FIG. 4.

FIG. 6 is a logic flow diagram applying one embodiment of the present invention to describe an exemplary business service.

FIG. 7 is a block diagram showing a suitable computer system for use with a method according to the present.

FIG. 8 is a schematic diagram showing a suitable environment for a method according to the present invention.

FIG. 9 is a schematic block diagram illustrating the overall system architecture according to one embodiment of the present invention.

FIG. 10 is a first screen shot of an implementation of a platform according to the present invention as modeled by FIG. 9.

FIG. 11 is a second screen shot of an implementation of a platform according to the present invention as modeled by FIG. 9.

FIG. 12 is a third screen shot of an implementation of a platform according to the present invention as modeled by FIG. 9.

FIG. 13 is a fourth screen shot of an implementation of a platform according to the present invention as modeled by FIG. 9.

FIG. 14 is a fifth screen shot of an implementation of a platform according to the present invention as modeled by FIG. 9.

FIG. 15 is a sixth screen shot of an implementation of a platform according to the present invention as modeled by FIG. 9.

FIG. 16 is a seventh screen shot of an implementation of a platform according to the present invention as modeled by FIG. 9.

FIG. 17 is an eighth screen shot of an implementation of a platform according to the present invention as modeled by FIG. 9.

FIG. 18 is a ninth screen shot of an implementation of a platform according to the present invention as modeled by FIG. 9.

FIG. 19 is a tenth screen shot of an implementation of a platform according to the present invention as modeled by FIG. 9.

FIG. 20 is an eleventh screen shot of an implementation of a platform according to the present invention as modeled by FIG. 9.

FIG. 21 is a twelfth screen shot of an implementation of a platform according to the present invention as modeled by FIG. 9.

FIG. 22 is a thirteenth screen shot of an implementation of a platform according to the present invention as modeled by FIG. 9.

FIG. 23 is a fourteenth screen shot of an implementation of a platform according to the present invention as modeled by FIG. 9.

FIG. 24 is a fifteenth screen shot of an implementation of a platform according to the present invention as modeled by FIG. 9.

FIG. 25 is a sixteenth screen shot of an implementation of a platform according to the present invention as modeled by FIG. 9.

FIG. 26 is a seventeenth screen shot of an implementation of a platform according to the present invention as modeled by FIG. 9.

FIG. 27 is an eighteenth screen shot of an implementation of a platform according to the present invention as modeled by FIG. 9.

FIG. 28 is a nineteenth screen shot of an implementation of a platform according to the present invention as modeled by FIG. 9.

FIG. 29 is a twentieth screen shot of an implementation of a platform according to the present invention as modeled by FIG. 9.

FIG. 30 is a twenty-first screen shot of an implementation of a platform according to the present invention as modeled by FIG. 9.

FIG. 31 is a twenty-second screen shot of an implementation of a platform according to the present invention as modeled by FIG. 9.

FIG. 32 is a twenty-third screen shot of an implementation of a platform according to the present invention as modeled by FIG. 9.

### DESCRIPTION OF THE INVENTION

The present invention, described herein and illustrated in the accompanying figures of the drawing, is portrayed through the use of exemplary embodiments that represent its spirit and scope. Further, in the various figures, certain components may be omitted to more clearly illustrate a particular aspect of the invention. And, those skilled in the art will appreciate that various combinations of elements, substitutions of elements, omissions and deletions of elements will not deviate from the spirit and intent of the present invention. The scope of the invention shall be limited only by the appropriate construction of the claims that follow.

### A. Overview of System and Method: Structure and System Entities.

In one embodiment the present invention provides a platform for orchestrating the outsourcing of targeted business processes. Targeted business processes to be outsourced are identified by the client business entity (customer) based on an analysis of the customer's core-competencies. This analysis may be performed in-house or by utilizing components of the systems and methods of the present invention. Then, logical decisions based on resource allocation (including costs, time constraints, specialization required, precision, accuracy, and quality, for example) drive the selection of outsource-ready processes.

Having identified potential outsource-ready processes, service providers external to the customer are contracted to achieve goals according to time, budget, quality, and cost constraints. The present invention enables intelligent selection of one or multiple service providers based on various metrics managed by the system and methods of the present invention. The outsource-ready processes are commoditized and individual tasks are commoditized and assigned to specific service-providers based on the rating, ability, and competency of the specific service provider.

Then, upon completion of the outsource-ready processes by the service providers, the commoditized tasks are re-integrated. Thus, the customer receives completed business processes in a transparent and seamless product provided by the systems and methods of the present invention. In sort, the present invention enables a holistic solution from a network of global service providers.

Service providers can be people, entities, or machines. A service provider can be internal to an organization or an external, third-party to the organization. For example, a service provider could be an accounting department in a large law firm, or a copy machine in a copy center, or an individual within the organization, such as a secretary. Service providers can be external to the organization and can include third-party contractors, which could be an individual or an entire independent organization. Service providers can also be internal to the organization but at a geographically separate location.

A remote host includes a server such as a computer or a distributed network using the world-wide web.

The system and methods of the present invention include three primary system entities. Each entity enables the interaction of clients (or customers) with service providers as necessitated by the type of interaction. The three primary system entities are:
A process outsourcing logic-structure entity, termed “bizExternalizers”;
A solution providing logic-structure entity, termed “bizExecutors”; and
A process expert logic-structure entity, termed “bizExperts”.

### 1. BizExternalizer (or Externalizer or Service Consumer): A means for Process Outsourcing.

The Externalizer entity, a means for process outsourcing, enables a particular customer to locate an appropriate service provider. The present invention associates the best service providers from a global market with the particular customer. The present invention enables a location-transparent, well-orchestrated, end-to-end Business Process Automation and Fulfillment (“BPA&F”) product and service in an on-demand environment. This enables a customer to utilize a scalable and global process-execution based service-provider community.

The present invention enables customers to outsource their non-strategic processes to a comprehensive, highly efficient execution platform with measurable goals of 100% client satisfaction. By outsourcing non-core services, clients focus on their strategic objectives and economize their operations.

### 2. BizExecutor (or Executor or Service Provider): A means for Solution Providing.

Service providers, termed Executors, interact with the systems and methods of the present invention to better enable particular customers to locate and hire specific service providers based on customer needs and service provider abilities. The present invention enables the service providers present the nature of their services to a global customer market base using a world-class technology platform.

Service providers promote their own competencies, without allocating significant resources, to a market of global customers. The systems and methods of the present invention handle this global promotion of the particular service-provider's core-competencies, while simultaneously promoting similar (competitive) service providers and service providers of other, non-competing, services.

The present invention includes systems and methods to enable a virtual, global marketplace of customers and service providers. The service provider community allows a customer to pick and chose specific outsourcable commodities and target competitive service-providers. At the same time, individual service providers—while competing with other service providers—also have exposure to a global market of customers without the expense or complexity of traditional marketplaces. The present invention includes marketplace components that provide a global exposure to both customers and service providers without any marketing expenses. The total value proportion is very appealing to all kinds and sizes of bizExecutors in a broad spectrum of business verticals.

### 3. BizExperts (or Experts or Process Experts): Means for providing process experts.

The bizExperts entity provides a self-driven community of process and industry experts, who will help the bizExternalizers, identify their externalizable services and effectively leverage the platform to get their processes executed.

They become independent sales entity, generating their revenue from leads provided to the platform. They also bring credibility to the Platform and help our bizExternalizers. They will help reshape, how companies get their services fulfilled. It is a three-way win.

B. Products and Services

### 1. Process Externalization Marketplace (PEM)

PEM, a marketplace framework, enables the creation of competitive and efficient marketplaces for different vertical business areas and brings an optimal balance between price and quality into each marketplace. The PEM framework brings a degree of faith into the marketplace that drives healthy competition, which directly relates into best of breed efficiencies and the bottom line cost reductions to customers.

PEM provides a self-regulatory structure for market participants. New participation is not just welcomed but encouraged, yet is restricted to genuine participants and provides a level playing field for all participants. Integrity is measured daily and information within it flows quickly, democratically and accurately.

Further, the present invention includes a bizExecutor Rating means for understanding the quality of the services of particular service-providers and provides a rating schema. This enables a feedback-based system for bizExternalizers to rate the bizExecutor based on their experience.

Process Executor Management Routing will be used by the platform to automatically route orders to bizExecutors based on bizExternalizers preferences.

### 2. Process Externalization Platform (PEP)

In one embodiment of the present invention, PEP (Process Externalization Platform) serves as the core platform and provides many value-added services to the process bizExternalizers and bizExecutors. Some of the sample core functions of the platform include:
(a) Comprehensive process status visualization, which is being executed by different service providers from all over the world;
(b) Process Automation, Process Choreography, Process Visualization and delivery for orchestrated processes which are serviced by different;
(c) Quality of Service Management visualization;
(d) Security functions on privacy and secure data scrubbing functions;
(e) Service Level Agreement (SLA) Definitions and Management;
(f) Contract Management;
(g) Quoting;
(h) Pricing;
(i) Profile Management (e.g.) Six Sigma processes, etc.;
(j) Legal, regulatory, and related compliance interfaces. (e.g. environmental compliance and reporting, Chain of Custody in legal services, HIPAA in Medical, Sarbanes Oxley in Financial Services, etc.);
(k) Business Rules Management;
(l) Visual modeling tools for bizExternalizers to define the process and bizExecutors to understand the requirements;
(m)Business Rules Engine, which can be used to allow customers to manage their parameters;
(n) Provide secure service (e.g. Web Services) interface that can be quickly integrated with the platform; and
(o) Industry Standards based XML messaging facility (e.g.) ebXML, LegalXML, etc.

### 3. Process Externalization Collaboration (PEC)

The present invention provides a seamless collaborative environment between our bizExternalizers, bizExecutors, and bizExperts, which greatly improves efficiencies. The PEC opens up multiple, real-time collaboration between the bizExternalizers, bizExecutors and bizExperts through multiple channels, such as online chat, online audio, online video, online audio and video, auditable agreements, etc. The bizExternalizers can effectively collaborate with bizExperts and bizExecutors on process re-engineering and other externalization options.

### 4. PEP Smart Appliances (PEPSAs) or Smart Process Integration Appliances

The present invention includes Process Externalization Platform Smart Appliances “PEPSAs” that enables seamless and rapid integration of corporate systems such as ERP, Supply Chain and other similar systems to the Platform and the bizExecutors, to externalize just about any process and provide a highly secure, efficient, completely automated, cost effective operating environment.

The present invention includes a variety of appliances suited to customer-specific business type and size. Also, a subset of the services, for example, provided through this platform includes:
(a) A system to perform Intelligent commoditizing of business services into atomic unit of works which can be routed to individual service processors across the globe and seamlessly assembled back again as a transparent orchestration;
(b) A system which can be used to standardize business services, which can be sold on the web, like a typical product, which is fulfilled through a network of global services providers;
(c) Smart process integration devices and appliances provides integration with the customer's software systems and organization. This enables a seamless and a virtual extension of the customer's infrastructure—and is not managed by the organization directly. Management of the smart process integration devices occurs external to the customer as part of the systems and method of the present invention. This allows the service-provider host, using the present invention, to specialize and economize, which enable the customer organizations to save money and simultaneously attain support by a highly sophisticated support organization that who is extremely savvy with highly scalable technology;
(d) Provide an execution platform for business processes, bringing the process executors and process outsourcers. All the processes are executed through the platform;
(e) Enable software System that utilize proprietary Artificial Intelligence Techniques to provide selection of service providers through availability, execution capability, ranking, rating, feedback system and other logistical parameters;
(f) Provide a Process Modeling tool, which can visualize the steps of the process;
(g) enable an automated, self-fulfilling, and self-healing platform;
(h) Guarantee business continuity, by automated routing;
(i) Provide multiple offering to the client for level of integration and automation;
(j) Enable a virtual extension of the organization without the overhead of managing resources;
(k) Facilitate real-time collaboration services, where the externalizers can communicate with the Platform and the executors;
(l) Enable a subscription-based enrollment for process executors, which would include screening and contract negotiations;
(m)Provide an automatic routing of processes based on load and availability;
(n) Enable competitive process executor pricing, who can be located any where in the world. The location of the processors is transparent;
(o) Enable one-stop-shopping for all the outsourced process needs of organizations;
(p) Enable revenue producing opportunities including a revenue model whereby a percentage of the execution fee for each transaction executed through the platform is automatically tallied; and
(q) Provide reusable technology assets for each vertically-aligned customer. The platform uses a strong generalized code base build. Thus, revenue margins can grow exponentially, with very little support and customization.
   Example of the present invention: The start-up company model.

One illustrative application of the systems and methods of the present invention includes a typical start-up business scenario. In this model, the present invention facilitates vital business functions that fall outside the core-competencies of the start-up business. For example, a start-up business entity (“start-up”) has certain core competencies in research, product development, and sales; however, accounting services including payroll, taxes, and recordkeeping are not core competencies and the Start-up lacks these skills in house. Similarly, Start-up wishes to comply with all local, state, and federal laws and, therefore, requires legal services. Additionally, Start-up desires a national sales-representative team to saturate the market beyond their current in-house capabilities. Start-up utilizes the methods and systems of the present invention to (a) commoditize the outsource services, (b) evaluate potential service providers, (c) contract with the selected service providers, (d) allocate specific tasks to specific service-providers, and (e) re-integrate atomic commodities, seamlessly. Moreover, discrete steps (a)-(e) are performed in an integrated, seamless manner by the systems and methods of the present invention and, therefore, are invisible to the customer start-up of this example.

More specifically, using Start-up's needs for outsourced accounting services, the systems and methods of the present invention commoditize accounting services into atomic sub-units; for example, daily book-keeping of accounts receivable is one commodity, daily book-keeping of accounts payable is a second commodity, drafting checks for payment is a third commodity, payroll accounting is a fourth commodity, auditing books is a fifth commodity, preparing quarterly statements to the IRS, is a sixth commodity, and so, on. This commoditizing, however, is performed by the system and methods of the current invention. Moreover, each commodity may be further reduced into atomic units or sub-commodities and, therefore, be further distributed among many individual service providers.

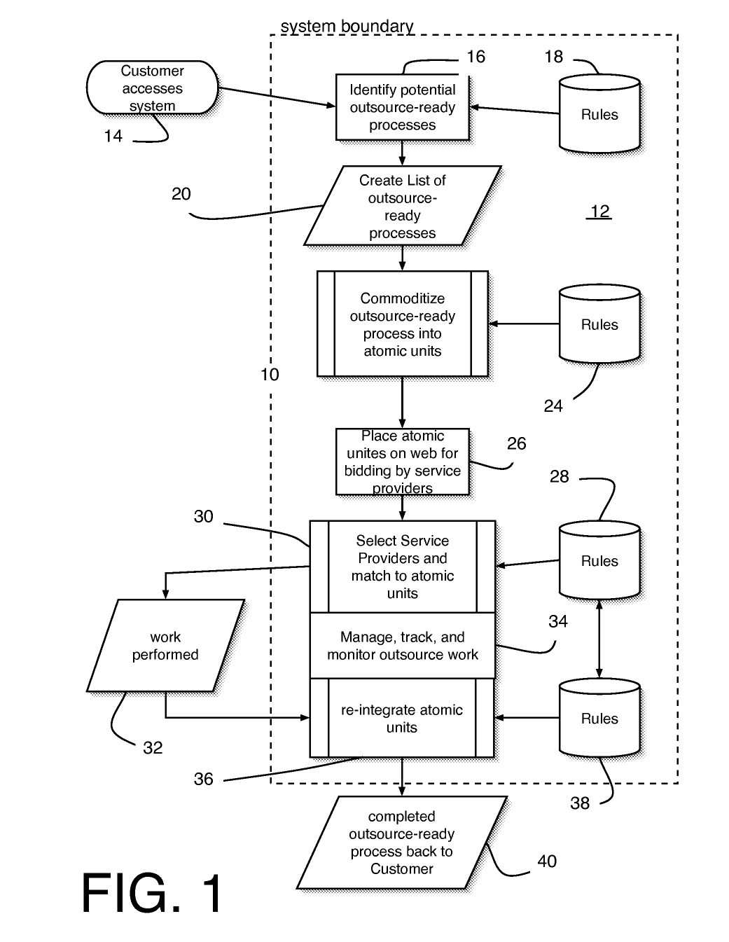

FIG. 1 shows a macro-level flow chart of the system and method according to one embodiment of the present invention. For example, using the Internet, a customer 14 interacts with the methods and systems of the present invention 12, represented by the tasks within the hatch-line boundary 10. A process outsourcing logic-structure entity 16, such as bizExternalizers, is enabled by various algorithms, rules and heuristics (collectively represented by block 18) to identify potential outsource-ready processes. A list of outsource ready processes (block 20) is generated. This process is transparent to the customer but allows manual manipulation by human experts or, alternatively, can be optimized by using process tuning algorithms, rules, and heuristics (not depicted in FIG. 1). Then, the selected outsource-ready processes are sub-divided into atomic task units 22 by applying specific rules 24.

The atomic tasks are now ready to be bid or bought directly by subscribing service providers (represented by block 26). A specific service provider may be awarded a single atomic task, or multiple atomic tasks derived from one or multiple outsource-ready processes for a given customer (block 30). The atomic task is performed by the service provider (block 32) then re-integrated upon completion (block 36). During the outsource phase (block 32) the present invention 12 monitors, tracks and otherwise manages each outsourced atomic task to assure schedule compliance or to alert the customer of delays (block 34).

Upon completion of all atomic tasks, the outsourced work is re-integrated (block 36) and a finished product is presented to the customer (block 40), as a seamless product or process result.

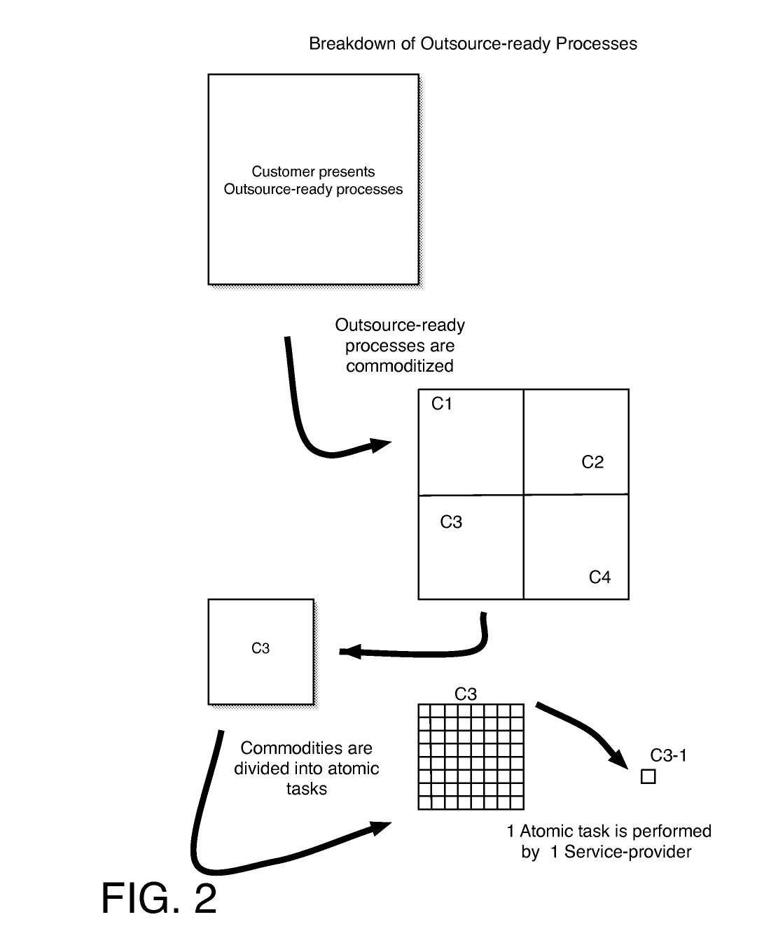

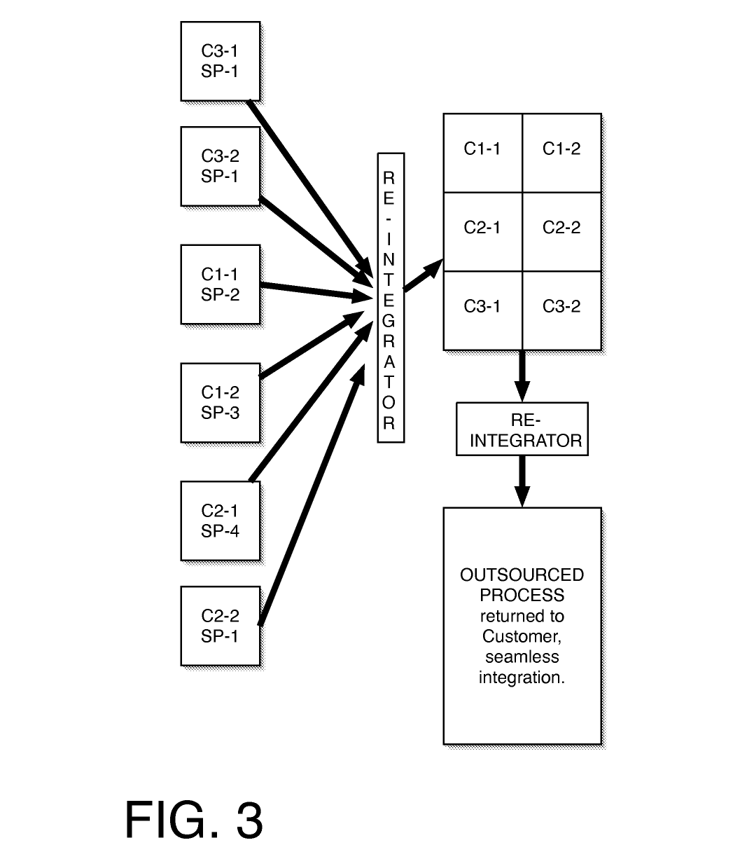

FIGS. 2 and 3 illustrate the breakdown and re-integration of an outsource-ready process presented by a customer. In FIG. 2 the customer presents an outsource-ready process. This process is determined by the customer, or by applying a portion of the present invention that enables the customer to decide which specific process is a candidate as an outsource-ready process. The present invention's methods and systems commoditize the outsource-ready process into a plurality of components, represented by C1 . . . C4 in FIG. 2. These components (C1 . . . C4), in turn, are divided into atomic tasks, represented by C3-1l . . . n. Each atomic task is presented to a community of service providers. Using the systems and methods of the present invention a specific service provider (SP) is selected to perform a specific task. FIG. 3 shows the re-integration of the various atomic tasks (C1-1, C1-2, C2-1, C2-2, C3-1, and C3-2). The customer is presented with a finished product. The finished product is seamless, that is, the customer was unaware of the commoditizing and atomic-division of the process into tasks and the re-integration. An advantage of this method is the ability to distribute manageable tasks to a world-wide population of service providers. Thus, both economies of scale and exploitation of favorable market conditions local to a particular community are placed at the disposal of the customer, without the customer needing to invent in relationships or actual overhead of managing operations on a global scale.

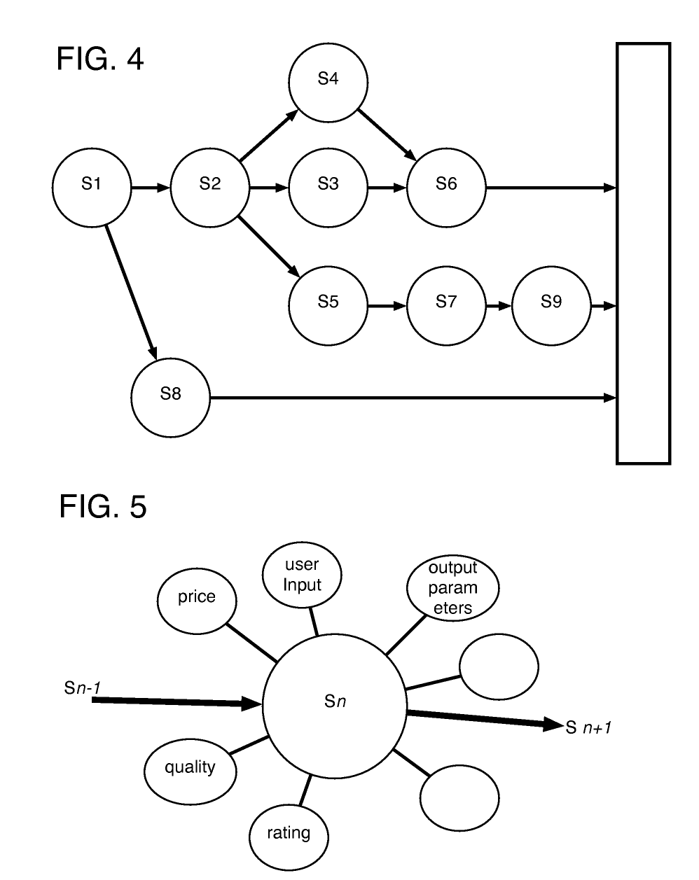

FIG. 4 is a schematic diagram showing a generic business process consisting of a number of individual business services, which are represented by nodes demarked by the letter “S” including S1, S2, etc. From this representational view of FIG. 4, it is understood that each individual business service Sn (S1, S2, etc) relates to other services. For example S1 represents the first service. It has no preceding node but has two immediately subsequent nodes S2 and S8. Thus, once the task associated with SI is complete both S2 and S8 can start simultaneously. Likewise, once the business service task S2 is complete, three subsequent business service tasks (S3, S4, and S5) can simultaneously commence. And so on, until the process is complete and the individual components are re-integrated. FIG. 6, a flow chart, uses a litigation document discovery process as a representative of a suitable business process for one embodiment of the present invention and is a specific example of the more generic example of FIG. 4.

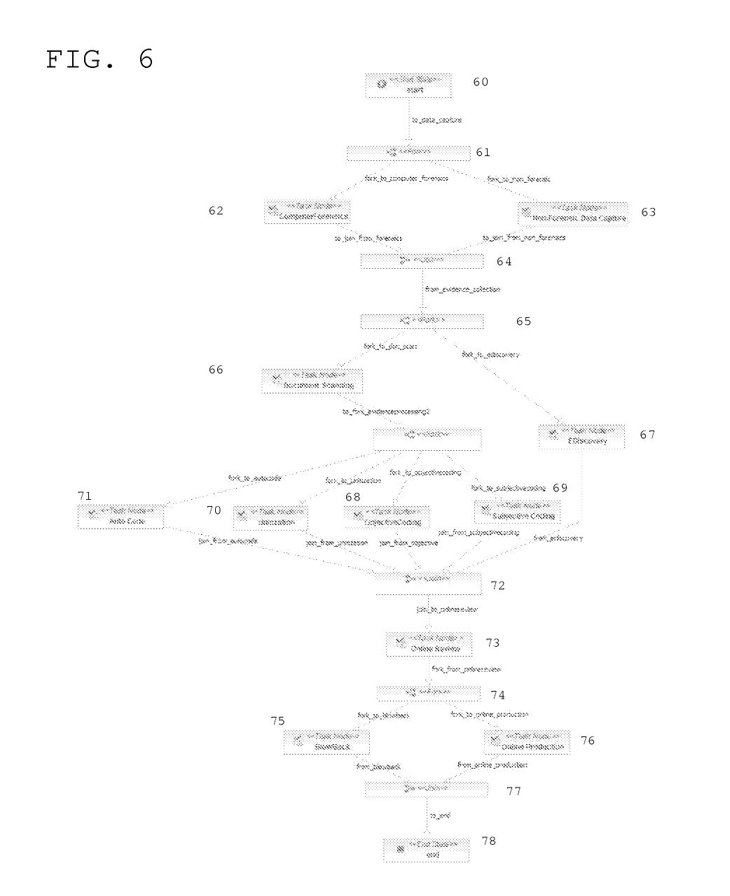

In FIG. 6, we see each node and the relationship to other nodes represented by lead-arrow lines. Therein a start node (block 60) initiates a decision (block 61) to capture discovery data either as Computer Forensic data (block 62) or as non-forensic data capture (block 63), or both. Then the when the forensic data capture is complete, the work is re-integrated (block 64) and the next service is selected (block 65), which consists of scanning non-electronic documents (block 66) and production of electronic documents (block 67). After non-electronic documents are scanned, the business services of objective coding (block 68), subjective coding (block 69), unitization (block 70), and auto-coding (block 71) commences. Then all the (now) electronic documents are reviewed and produced to the litigation team (block 72). The next atomic unit or sub task begins, which is an on-line review (block 73). Once this task or atomic unit is complete, two simultaneous operations start (block 74) including blow-back (block 75) and on-line production (block 76). When these atomic tasks are complete the work is re-integrated (block 77) and the finished product is ready, which is represented by the end node (block 78). This representative example enables those skilled in the art to appreciate one aspect of the present invention. This process uses the methods and systems of the present invention and was generically modeled in FIG. 5. Particularly, a given business service Sn (which could be any one of the nodes of FIG. 6, for example) has a number of parameters associated with it. These parameters include price, quality, vendor rating, time required to complete task, current capacity of vendor, and other user-defined parameters. Output parameters include task status, quality of work, percent completion and other user-defined output parameters. The present invention models any business service in the form of this generic model of FIG. 5. Then, each individual business service Sn is linked relationally to other business services (and thus, the diagrams of FIGS. 4 and 6 are generated). With this model constructed, the present invention enables a platform user to allocate work to specific service providers based on a real-time assessment of the various parameters. In another embodiment, the present invention applies intelligent heuristics to automatically allocate specific tasks to specific service providers based on an analysis of real-time data of the various input parameter and output parameters in a optimization algorithm.

Moreover, each business service (Sn) may be further divided among a plurality of service providers. Using the e-discovery model of FIG. 6, it would be understood that the task “Document Scanning” could be allocated to a number of service providers based on their present availability, capacity, estimated turn-around time, cost, etc. The present invention includes a method and tools adapted to split the task and allocate it to the appropriate service providers. The system also allows for splitting up of large amount of work to be spread across multiple service providers automatically for maximum scalability, in the most efficient manner.

In this embodiment a platform user (or a customer):

1. Interacts with the platform;

2. Selects from the productized list of services; and

3. Select the most suitable service providers from the Intelligent Marketplace.

This shows the improvements gained according to the methods and tools of the present invention. For example, the present invention:

1. Allows a customer to focus on their core business and leave the management to the technology platform for maximum cost savings, security, and efficiencies; and

2. Provides transparency into the whole process and obtain the end product.

Representative example: Book Digitizing

With everyone—from The US Library of Congress, local libraries, and corporations—trying to digitize books (so that it can be searched, viewed and sold online), ‘E-Books Creation’ is one of the growing business processes which will be massively outsourced across the globe. Billions of books and manuals are still waiting to be digitized. With the invented technology, it becomes as easy as logging onto a platform having the systems and methods according to the present invention, which coordinates a chain of events. This involves executing disparate business processes such as scanning the book, tagging and indexing the book, converting it into various formats, translating the book into other languages and converting it to audio format. Typically, different service providers provide these services. The technology can orchestrate these processes into a unified product. From picking up the books to delivering the e-books, the platform technology will provision the work through a network of highly rated service providers from all over the world. The customer has complete transparency from start to finish. With this technology, if the customer wishes to translate a book into another language it will be just a click away.

Today, digitizing books is a complicated and inefficient process for the medium to small organizations. It starts from selecting the right scanning vendor, the right tagging vendor, etc and establishing relationships with each one of them and managing the whole process manually. There is no transparency into the process and the ability to shop for the best service providers from all over the world, who can deliver a complete solution.

### Representative Example: Litigation Support.

The process of converting boxes and boxes of paper documents and terabytes of electronic documents into searchable, meaningful evidence for Litigators to defend or prosecute a case is one of the primary services offered by the litigation support industry. With lawsuits in all different sizes and shapes from intellectual property disputes to corporate fraud cases, this industry is growing at about 35% a year in the United States. Current estimates put the overall litigation support industry to be valued at about five billion dollars annually.

This industry is filled with inefficiencies and problems. Let's consider a simple scenario, where a medium sized law firm with 10 Litigators having several lawsuits to prosecute or defend. Most of the cases have some kind of discovery requirement. They subpoena several boxes of paper documents and a large amount of electronic data. The typical steps needed to transform raw data into meaningful evidence requires these steps:
1. Digitize the paper documents, which requires investments in specialized scanning equipments;
2. Recover data from hard drives and email programs, which requires special skills;
3. Index all the information based on the specification provided by the attorney, which is mundane and labor intensive;
4. Integrate all the work into an industry software, which can be used by the attorney to do searches which can provide valuable insight into the case.

The above services are performed by different service providers, each with varying expertise. As you can imagine, without any automation to manage this large effort, it can be costly, time consuming and error prone.

With the invented technology including software and hardware of the present invention, it becomes as easy as logging onto a website and buying the productized business services, as and when you need. This will coordinate a chain of events. This involves managing disparate business processes such as scanning the documents, recovering data from the hard drives, index and code the documents, and integrate the documents and indexes into the software.

Typically, different service providers provide these services. Exterro's™ proprietary technology can automate these processes, by provisioning the work through a network of verified service providers from all over the world. The invented technology provides complete transparency from start to finish. With this technology, if the customer wishes to buy another automated service such as ‘multi-dimensional visualization of case data’, it will be just a click away. This is also an example of Manual and Automated Process Weaving

Example of Smart Integration Appliances.

Consider a large multinational corporation whose Accounts Receivable systems needs the ability to outsource collections of overdue accounts. Today, the prior-art teaches that the entity needs to do an RFP process and find the service provider. Once the service provider is identified the system needs to be altered to integrate with the proprietary system of the service provider. This is a very costly and inefficient process. Now consider the scenario where the entity is not happy with the service provider. They have to go through the process of finding a new service provider all over again and modify their systems to integrate with the new service providers proprietary system.

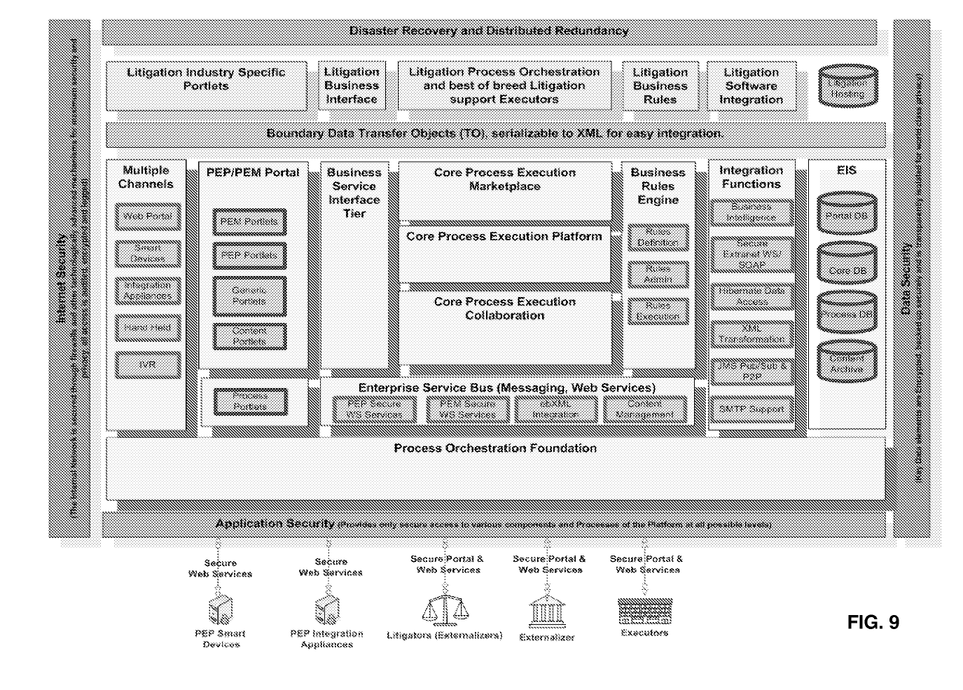

With the new invention the appliance or platform—consisting of a packaged combination of software and hardware—such as the computer shown in FIG. 9, for example, running electronic data files representing steps according to the present invention—easily integrates with the Enterprise's system. It fundamentally knows how to send the right information to the right service provider through the platform technology. This eliminates the process of the Enterprise redoing all their integration again. It makes the switching of service provider just a click away. This directly saves cost and improves efficiency. This can be easily orchestrated with other services transparently.

Any appliance that standardizes the integration to Enterprise Systems such as ERP, Supply Chain, etc and automatically sends information to be outsourced comes under the ‘Smart Process Integration Appliances’

Example of Smart Process Outsourcing Devices

Consider a Medical Practice: The practice desires to outsource their ‘Medical Transcription’ and ‘Billing’. Today according to the teaching of the prior-art, the medical practice must capture all the audio files in a recorder, transfer the files and upload it into a service providers FTP site. All the doctor notes needs to be scanned and uploaded a different service provider.

With the invention, smart devices, which is a customization of the recorder, would automatically capture the audio files and send the audio files to be processed to the platform through the Internet, which in turn provisions the work to the selected service provider. The other smart devices, which is a customization of scanning device automatically digitizes the images and sends the scanned images to the platform, which in turn provisions the work out the selected service provider.

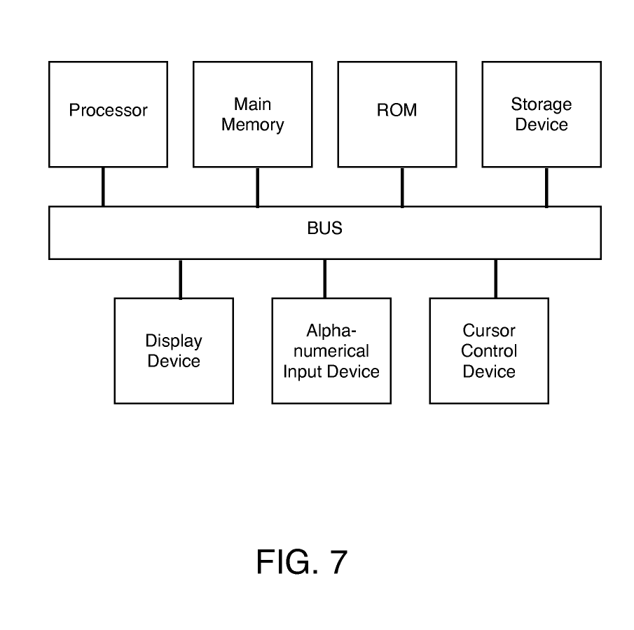

This immediately provides considerable cost savings and improvements in efficiencies. This also provides a one stop solution for the Medical practice to get their services outsourced through the pervasive platform. Accordingly, the present invention contemplates any such device which directly helps sending out work to be outsourced and eliminate other manual tasks are ‘Smart Process Outsourcing Devices’ One such device includes a computer, for example, as shown in FIG. 7.

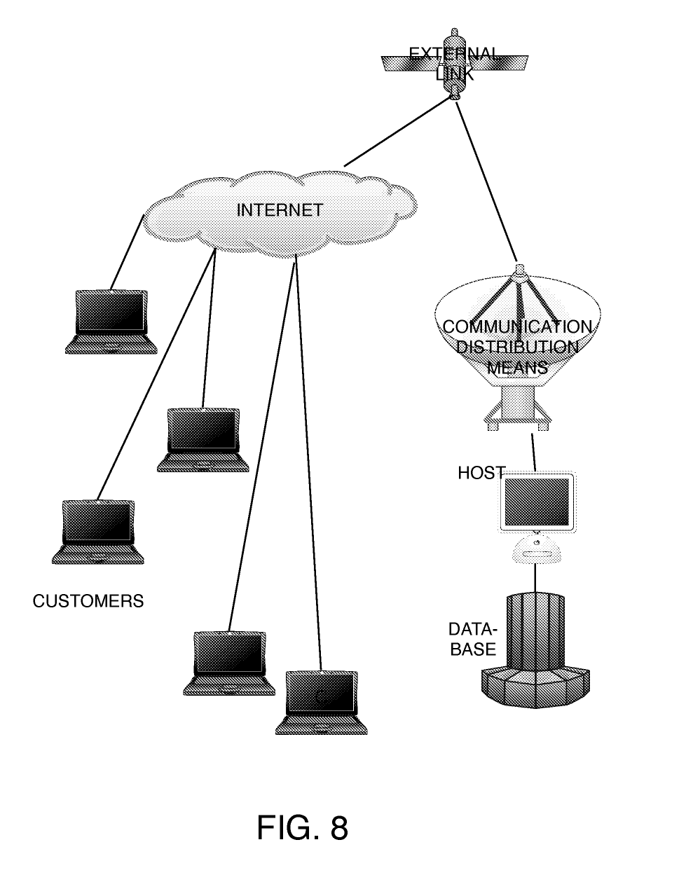

FIGS. 7 and 8 show a platform and environment, respectively, suitable for use with the tools and methods of the present invention. A modern computer contains software coding representing process steps according to the present invention, as shown in FIG. 9. Users, shown in FIG. 8 as laptop computers, interact with the host via a communication network, such as the Internet.

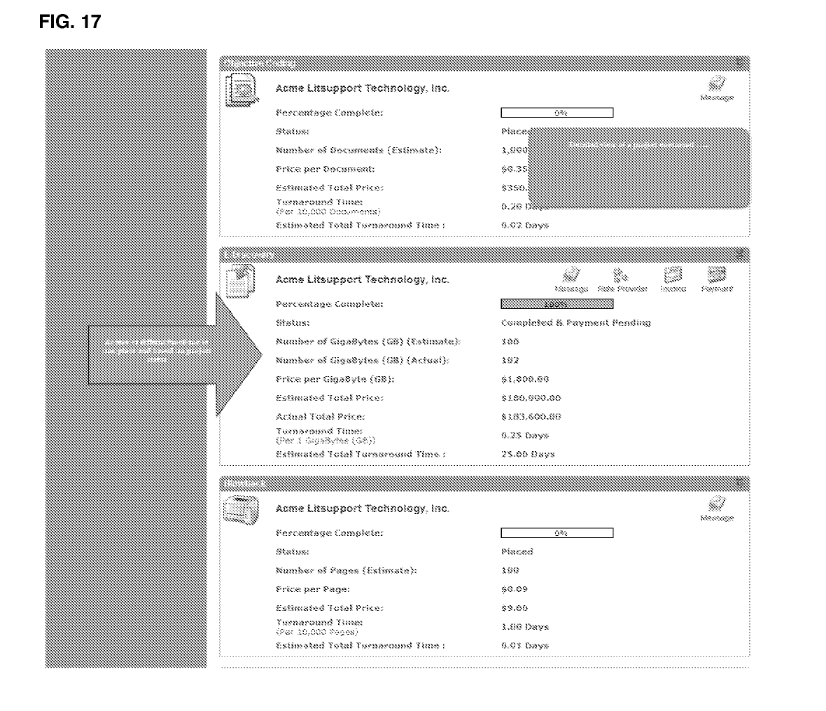

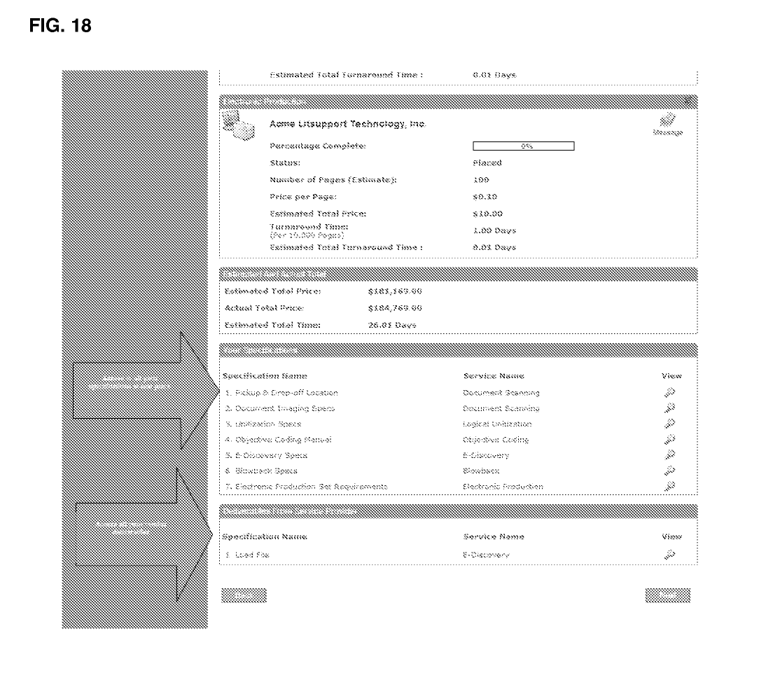

FIGS. 9-32 are various screen shots of a particular embodiment of the present invention adapted for use and execution on a computer system including a remote host relative to a plurality of international customers having business locations throughout the world and who access the platform via the Internet, using the world-wide-web as a communication portal to the remote host and platform, which serves a marketplace to exchange business services, report status, and otherwise enable communication to the plurality of users.

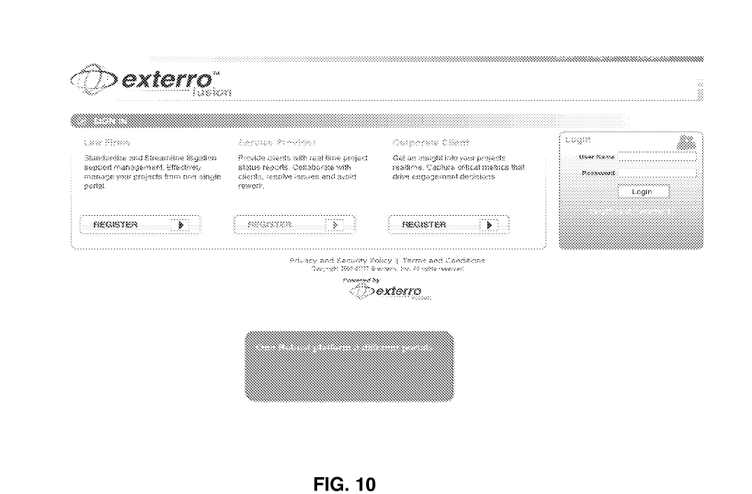

Specifically, FIGS. 10-32 illustrate a specific litigation process orchestration model. However, the present invention readily adapts to other uses and the litigation model is presented as a means for illustrating the applicability, adaptability and usability of the present invention.

FIG. 10 is a log-in screen for a customer (such as a law firm or corporate client) or a service provider (such as an entity that wishes to perform a business service for the customer). Recognizing that a customer or service provider has many individuals with varying responsibilities and authority within the organization, the system of the present invention enables unique log-in based on a user ID and password, that particular account, in turn, will have unique permissions and access levels as appropriate for that individual.

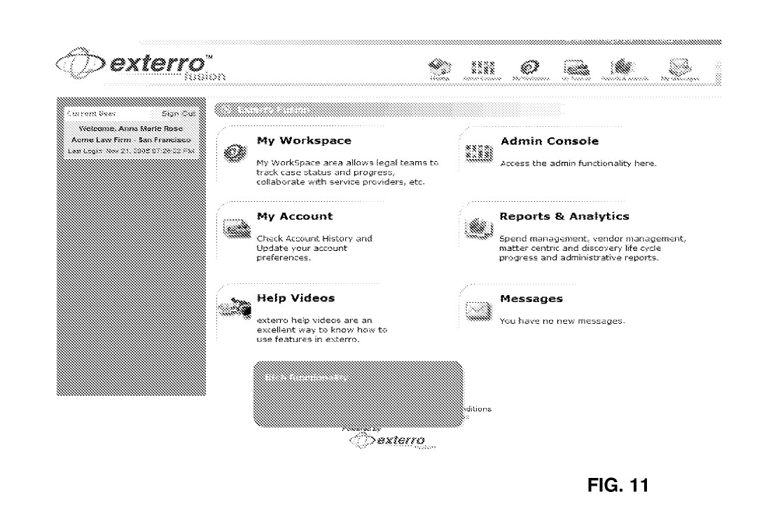

FIG. 11 is an initial desk-top screen that enables the user to select the type of interaction for the particular session including a message center, a tutorial section including help videos, reports and analytics menu, administrative functions, account preferences and a workspace.

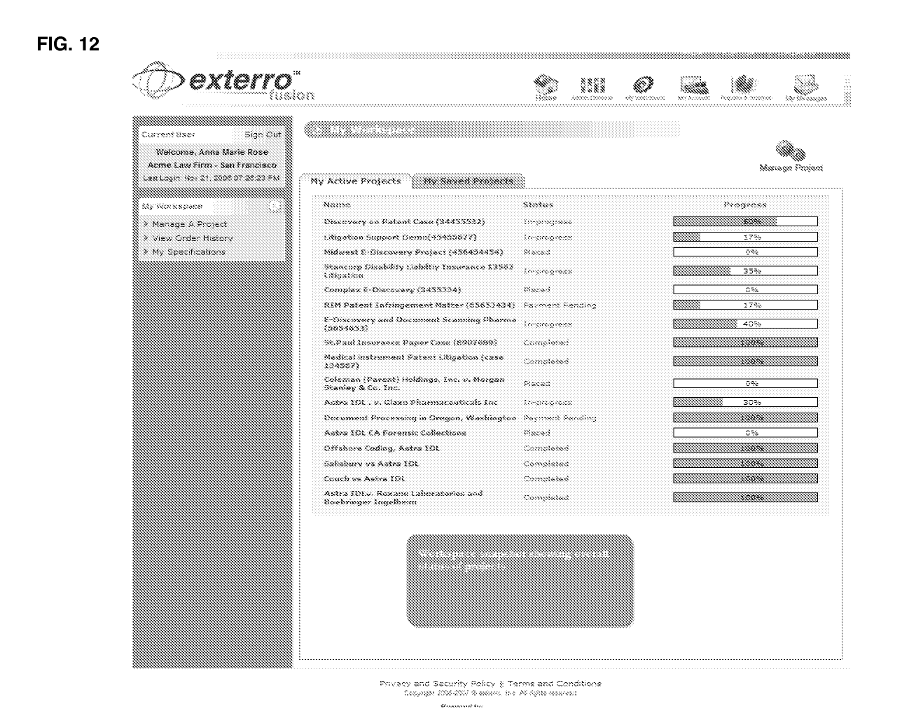

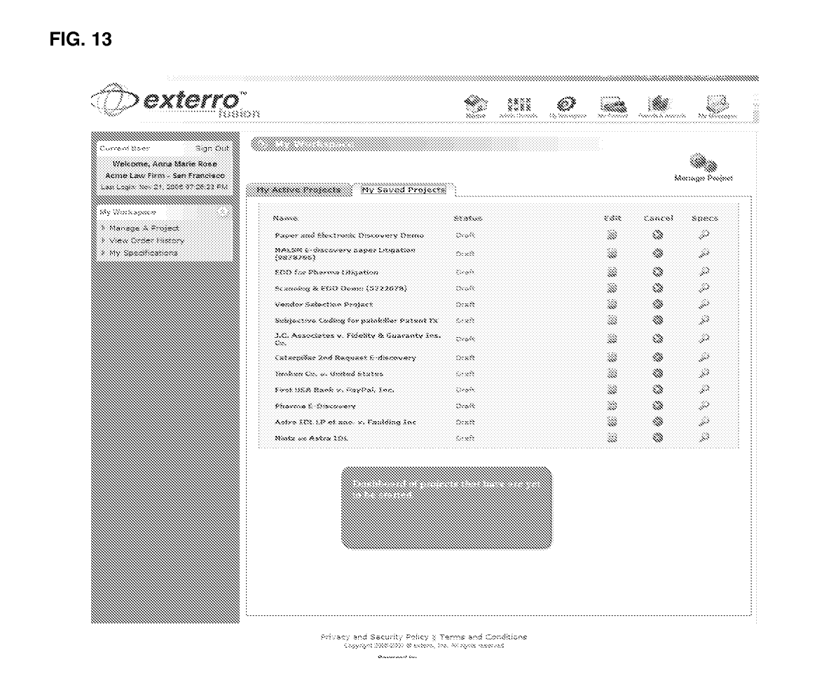

FIG. 12 is an example of the workspace screen highlighting this users active projects and the current status in a graphical format. For example, the first item titled “Discovery on Patent Case 34455532 is in progress and shows a 60% completion status. This snapshot is unique to the user, and may be specifically tailored based on the user ID during log-in. FIG. 13 is an alternate screen shot of the workspace screen highlighting this users saved projects.

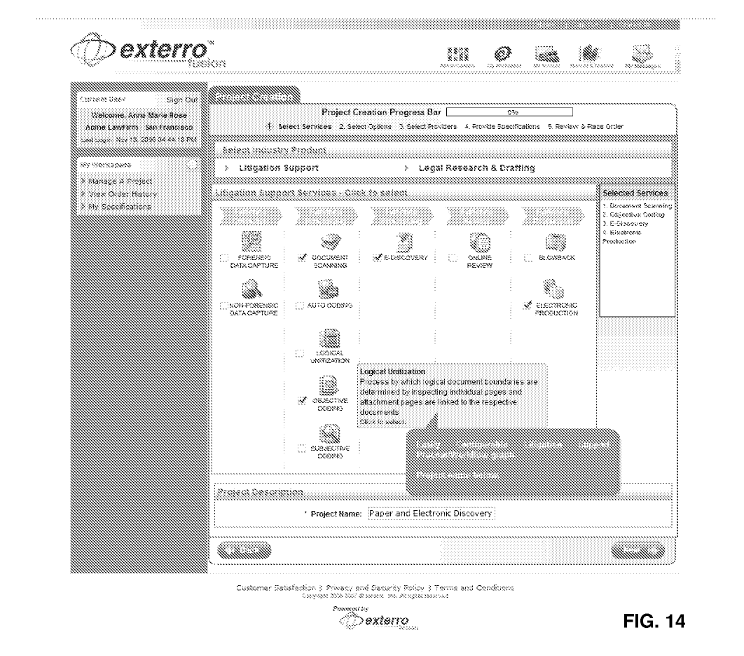

FIG. 14 is an example of a project creation screen. Here the user can define the business process (modeled generically in FIGS. 4 and 5) by simply clicking on the tic-boxes adjacent to the graphical item representing the specific task. Thus, for a litigation support project, the services desired in this representative example include document scanning, and objective coding, e-discovery, and electronic production of documents. The user can uniquely identify the project by a project name. Again, graphical displays enable the user to quickly understand the progress of the project or the specific task. In this view, the project completion status indicates a 0% complete.

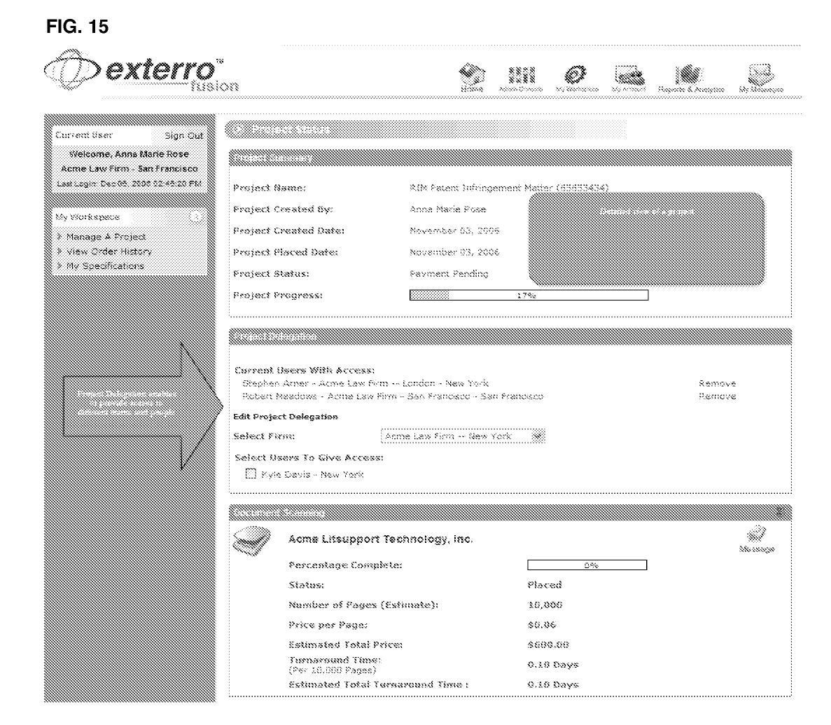

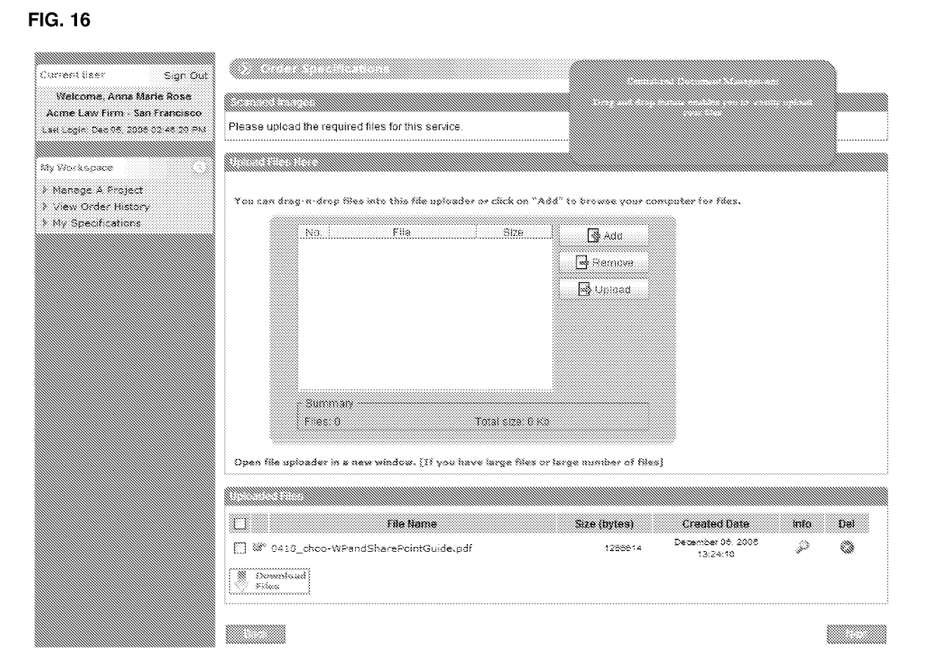

FIGS. 15-18 are portions of a single screen shot showing the current status of a selected project for a specific user. Here, this example shows that Anna Marie Rose of the Acme Law Firm has an active project entitled RIM Patent Infringement Matter 65653434. Specifically, this task is sub-divided into a number of business services, which are allocated to various service providers including Acme Litsupport Technology, Inc. From this screen, the user can determine that the document scanning has not been started and accordingly has a 0% completion status. Likewise, the objective coding and blow black is not underway. However, e-discovery is 100% complete with 102 gigabytes of data, and an actual total price of $183,600 due to the vendor Acme Litsupport Technology, Inc. Moreover, as FIG. 16 shows, the platform can be used to transfer data files. This screen shot shows a menu for sharing files between the user and the vendors.

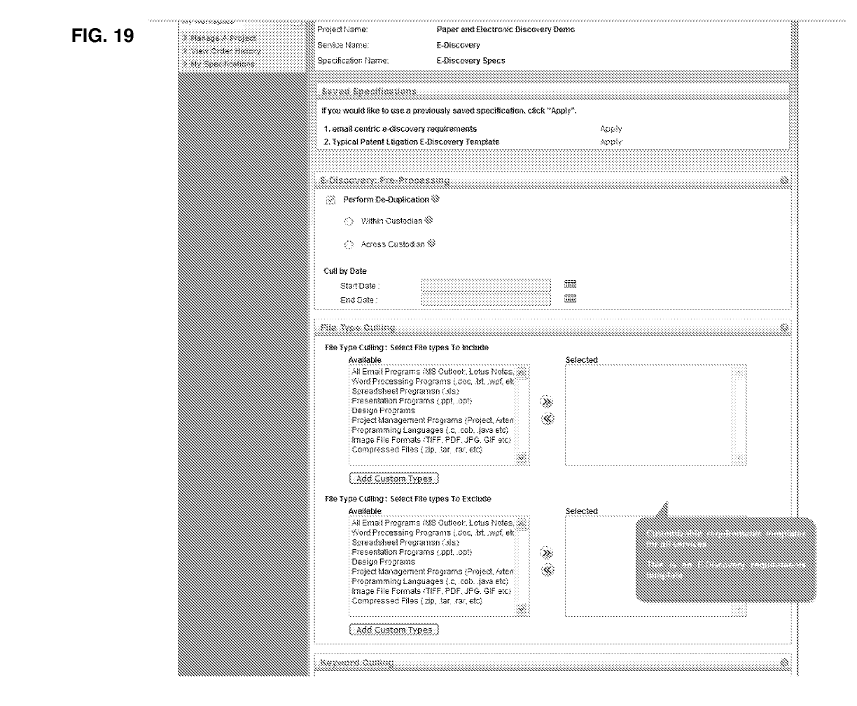

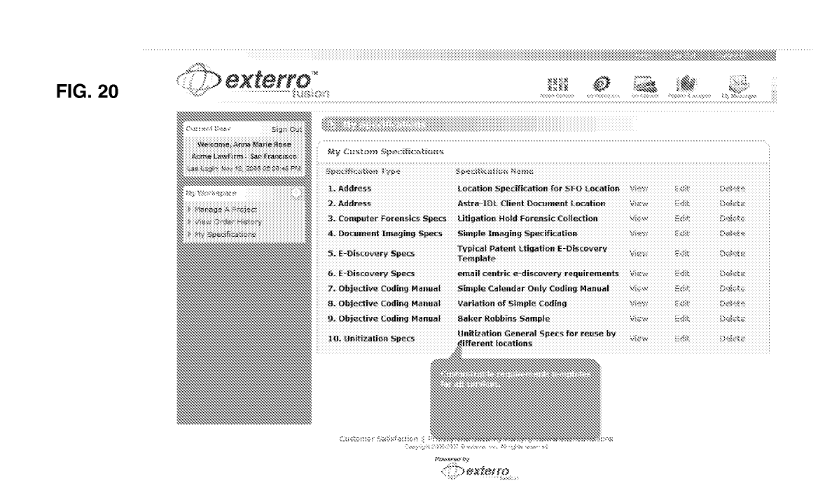

FIGS. 19 and 20, additional screen shots related to FIGS. 15-18, show customizable requirements defined by the user for each vendor.

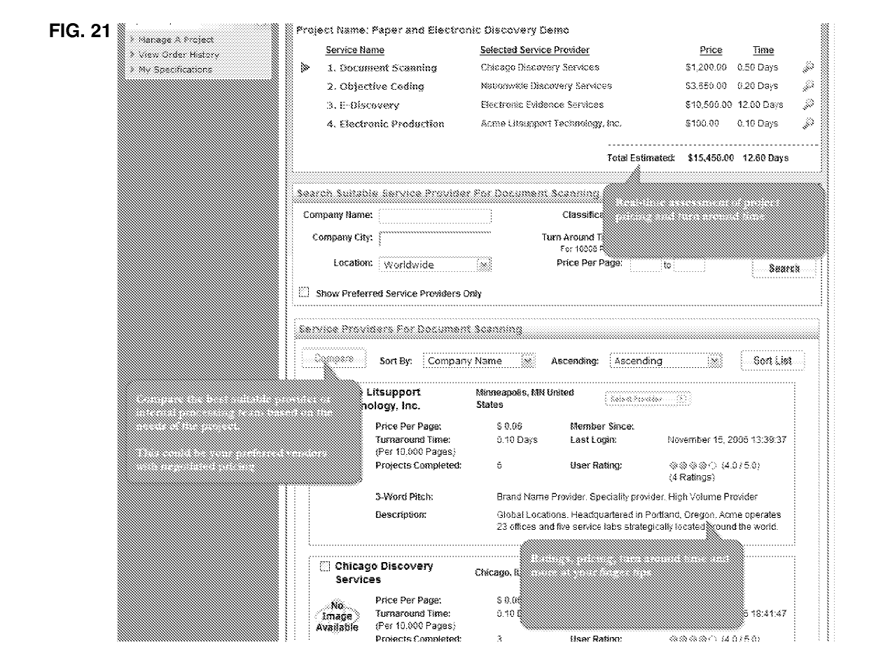

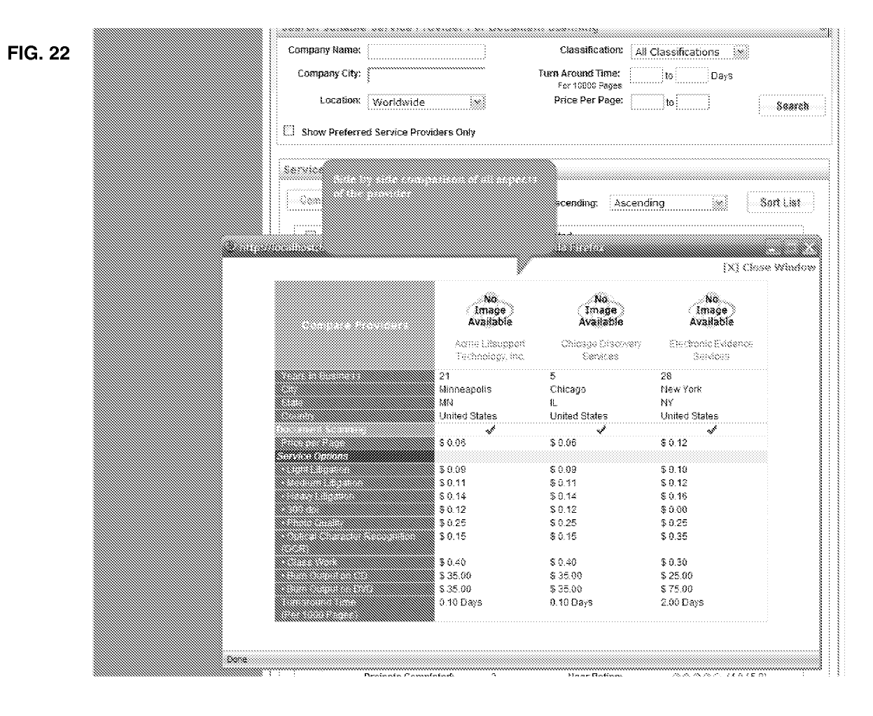

FIG. 21, another screen shot, enables the user to provide feedback, rating and input to each vendor associated with a particular project relating to the outsourced business process and services. The vendors provide input to the platform including price, capacity, turn-around time. Users rate the quality of the vendor. This information is combined and presented to the user when allocating work for a new project. The user can allow the platform to select the vendor or multiple vendors or, alternatively, the user may restrict the parameters to better control the allocation based on specific priorities of the given project. With these parameters established, FIG. 22 shows a possible sub-set of selected vendors that match the search parameters inputted by the user.

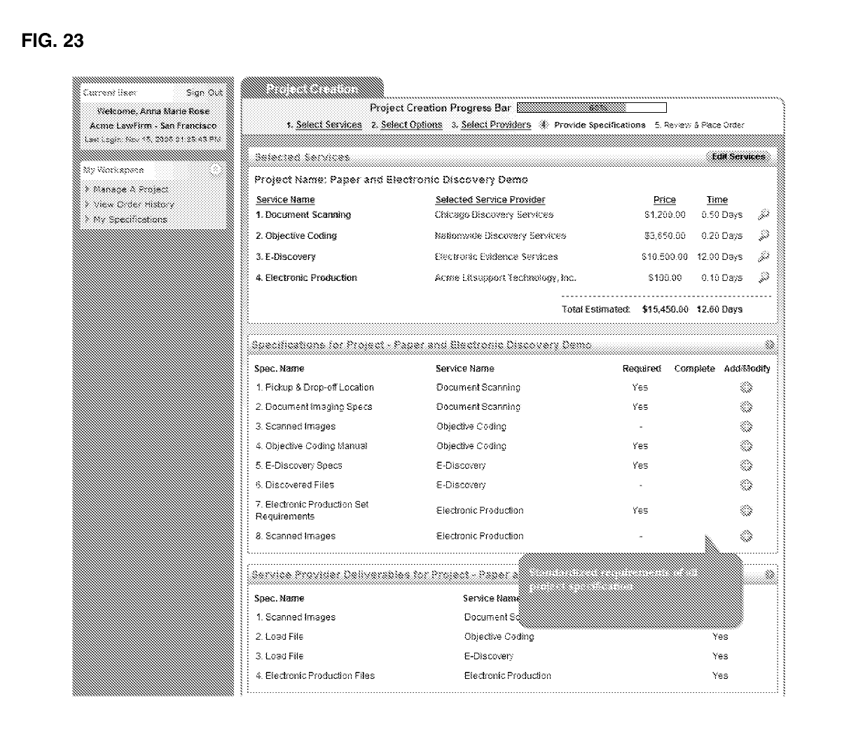

FIG. 23 further shows the progress of a project creation screen. Sixty percent of the creation process is complete at this stage and the specific tasks are identified. Currently, the unique vendors for the services are still being determined.

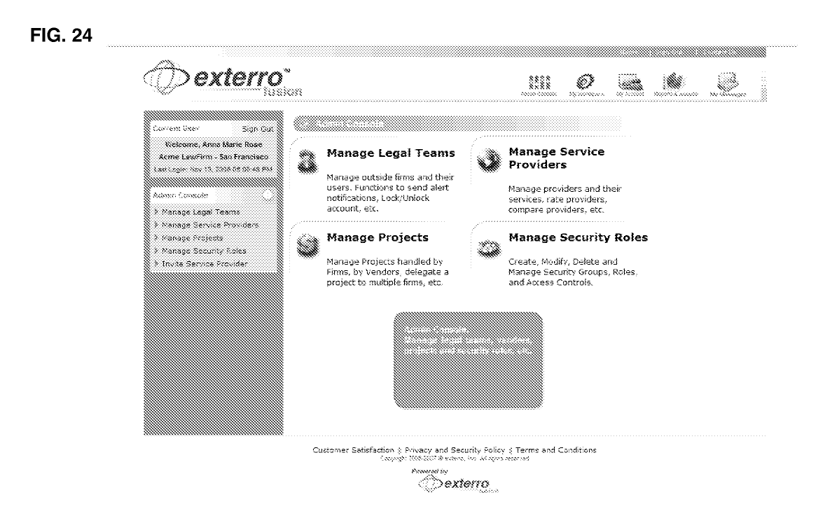

FIG. 24 shows another screen whereby a user can manage aspets of their account including the legal teams, service providers, projects and security.

This screen may be restricted to an administrator or team leader based on the initial log-in, for example.

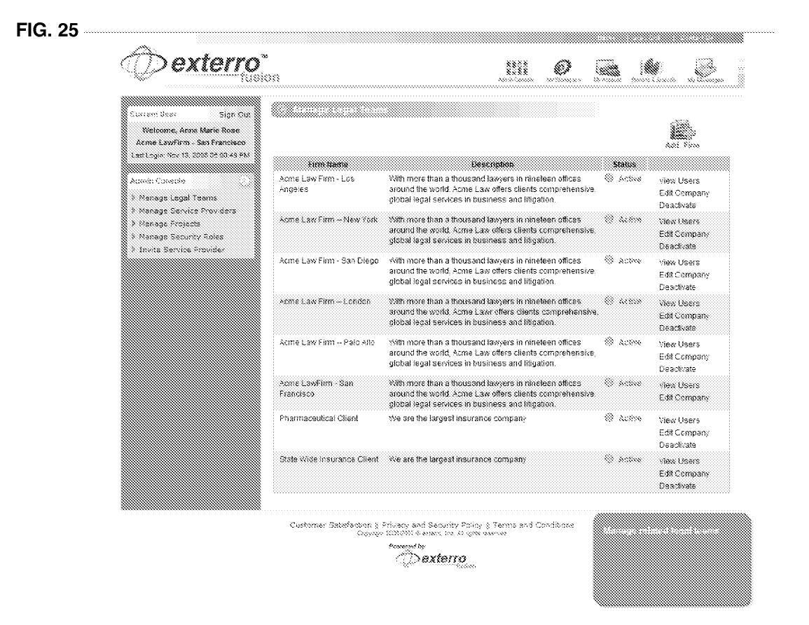

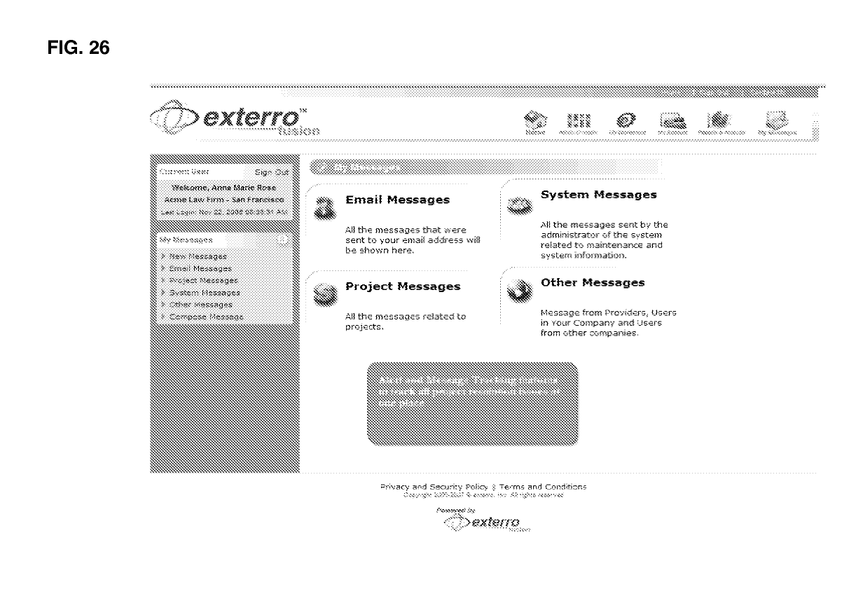

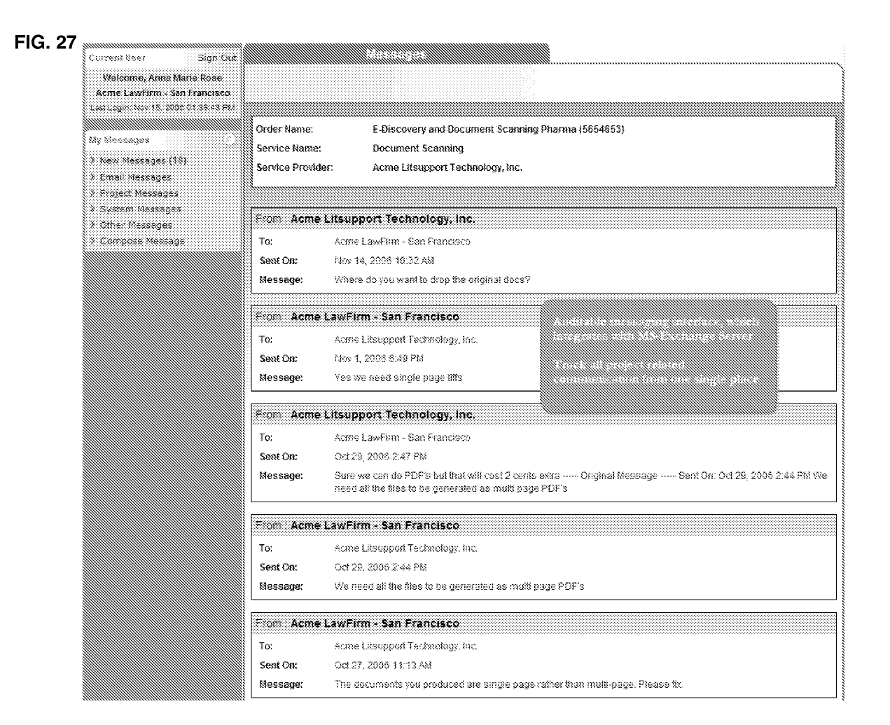

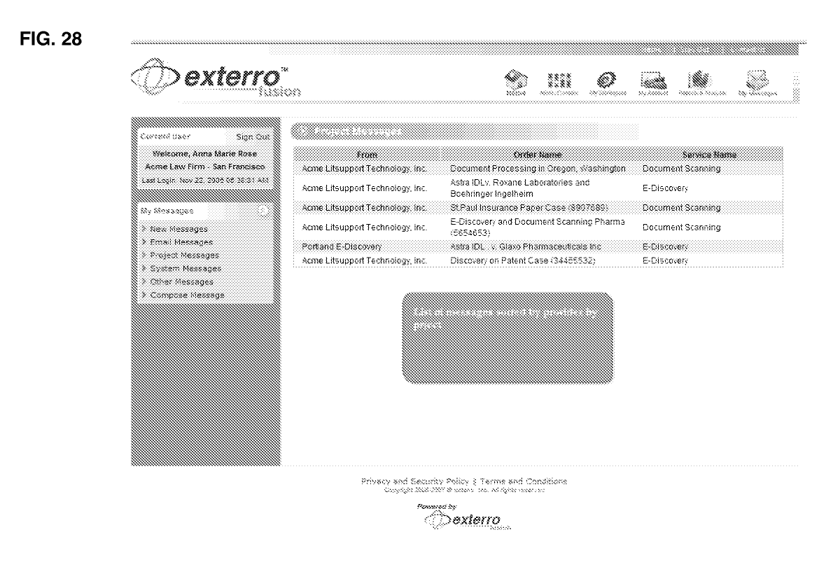

FIG. 25 shows another screen shot whereby a user can manage vendors. For example, a law firm has some pre-approved vendors approved for various outsourced business tasks. These vendors may have preferred billing arrangements that were previously established. A large entity may have divisions or branches that they may consider vendors for a particular task. The present invention enables a user to distribute work for a single project across multiple providers, yet maintain control of the status information. The present invention, as shown by FIG. 26, further includes means for communicating between users and vendors. And, as FIG. 27 shows, such messages can be interfaced with popular messaging software including MS-Exchange Server. Messages are conveniently arranged a presented to the user as shown by FIG. 28.

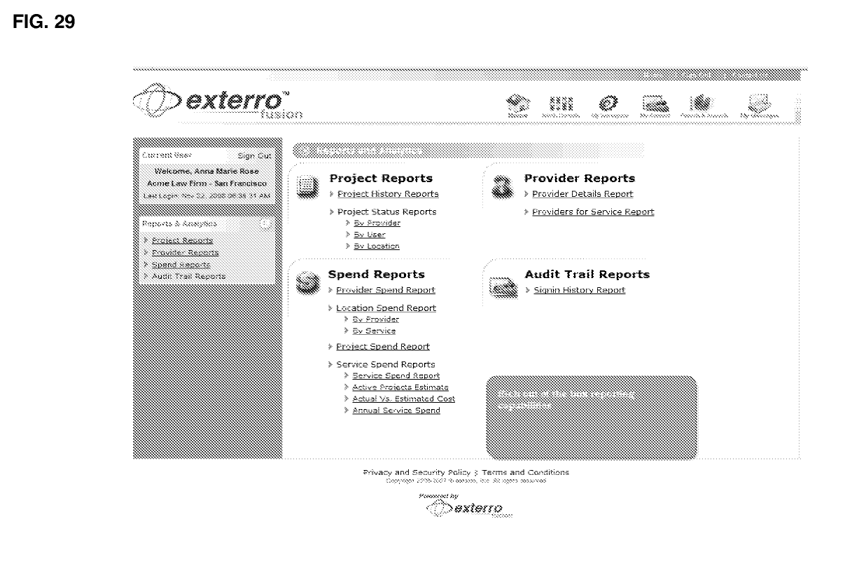

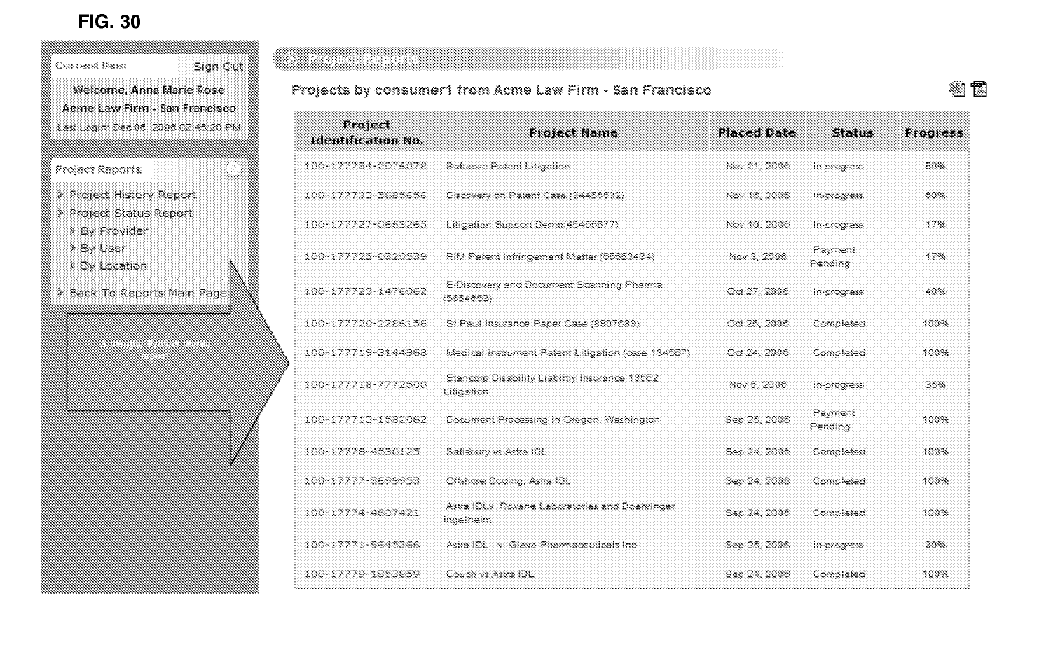

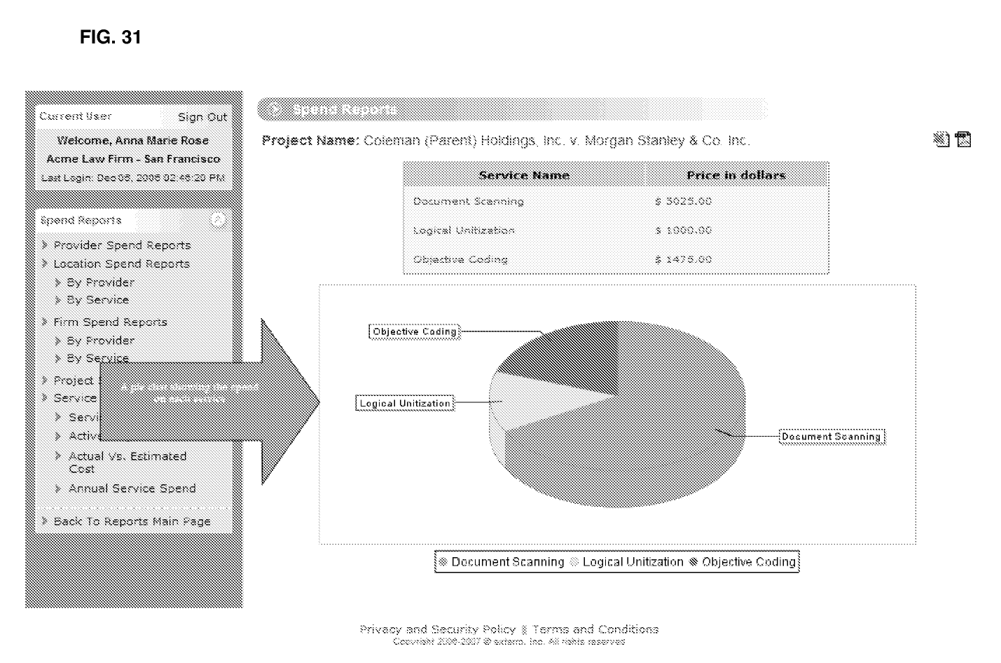

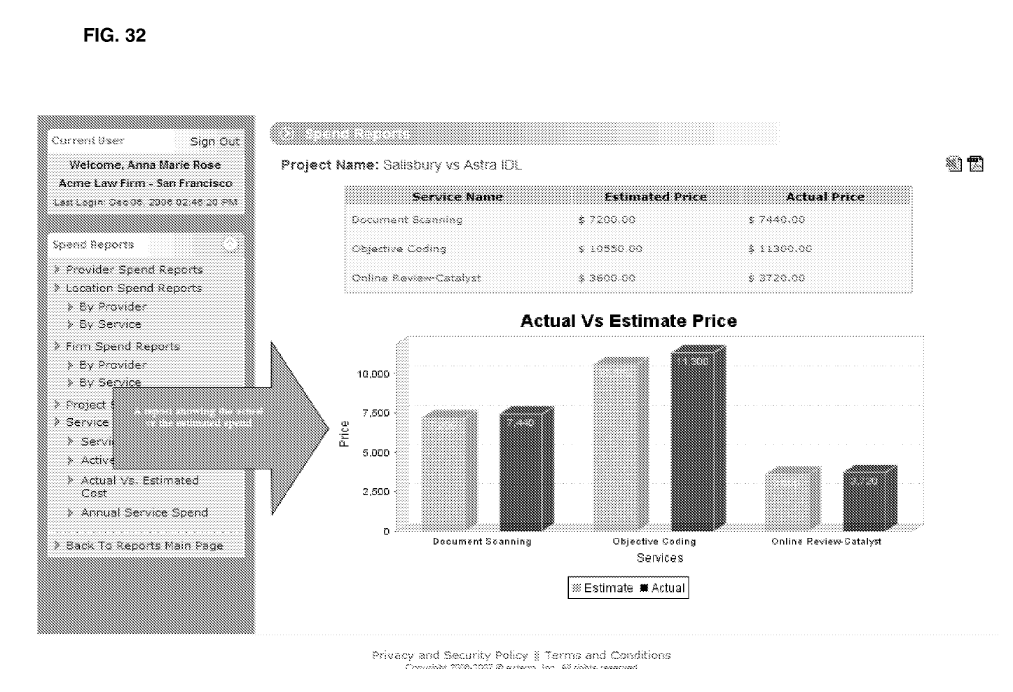

The present invention also provide analytics and reports to the user. FIGS. 29-32 show various report formats output to the user. A menu screen, FIG. 29, directs the user into various functional areas including project reports, service-provider reports, audit trail reports, and spending reports. For example, project reports, as FIG. 30 shows, are arranged by the project identifier, which is unique to the customer, and notes the name, date placed, status and progress of each project. Project status is also reported graphically, for example as a pie chart of FIG. 31 or a bar chart of FIG. 32.

In many of the figures the same reference numeral is used to demonstrate the same or a similar component in different embodiments of the invention. Some figures omit features to more clearly demonstrate certain aspects of the present invention. The foregoing embodiments of the present invention are intended as representational examples and should not be construed as limiting.

I claim:

1. A method comprising:
identifying potential outsource-ready processes according to a predetermined rule set;
creating a list of outsource-ready processes divided into atomic units according rules;
assigning atomic units to at least one service provider according to a predetermined process;
reintegrating atomic units; and
providing completed processes back to a customer.

2. The method of claim 1 further comprising managing, tracking, and monitoring outsourced atomic units.

3. The method of claim 1 further comprising storing a datafile on a computer readable data medium.

4. A method for enabling transactions on a distributed network, the method comprising:
providing a platform adapted to enable a plurality of users simultaneous access via the distributed network;
providing a first means for commoditizing a business service into atomic units;
providing a second means for assigning each atomic unit to a particular vendor; and
providing a third means for tracking the status of the progress of an atomic unit relative to the particular vendor.

5. The method of claim 4 further comprising:
providing a remote host;
executing the platform on the remote host and adapting the platform to enable the plurality of users to interact with the platform via the Internet.

6. The method of claim 4 further comprising:
orchestrating an outsourcing of the atomic unit to a given vendor based on an analysis of the vendor's core-competencies;
associating resource allocation to the vendor wherein variables including costs, time constraints, specialization, precision, accuracy, or quality, are used to determine the vendor from a set of vendors;
selecting the vendor using intelligent decisions based on the variables;
assigning a specific vendor a specific atomic task;
re-integrating a first atomic task with a second atomic task wherein both the first and second atomic tasks are related to the business service; and
providing a graphical user interface for displaying parameters of the platform.

7. A method for business process externalization, the method comprising:
providing means for a graphical user interface adapted to enable a user to visualize present status completion of the business service being commoditized;
providing means for process commoditization whereby the business service is divided in to sub-tasks termed atomic units;
providing a means for process allocation of the atomic units to any one vendor from a plurality of vendors;
providing means for a user to input parameters describing metrics for the vendor;
providing means for the user to define output parameters describing performance metrics for the vendor;
providing means for a plurality of vendors to describe current status metrics;
providing a rule-set for process allocation of the atomic units to one or more vendors based on the input parameters and the vendor status metrics;
providing means for a user-rules engine whereby the user manages the input parameters and output parameters; and
providing means for remote access to a computer system or platform serving as a market for users and vendors.

8. The method of claim 7 further comprising:
providing means analyzing a quality rating for a particular vendor using the input metrics and
providing means for a graphical display of the quality rating.

9. The method of claim 7 further wherein providing means for a plurality of vendors to describe current status metrics further comprises:
providing a means for the vendor to assign pricing for the atomic unit;
providing a means for the vendor to quote pricing for the atomic unit;
providing a means for the vendor to define current capacity for the atomic unit;
providing a means for the vendor to define turn-around time for the atomic unit; and
providing a means for the vendor to display a customer-satisfaction rating based on a previous user interaction with the vendor.

10. The method of claim 7 further comprising:
providing means for enabling a secure access of the platform.

11. The method of claim 7 further comprising:
providing a means for communicating with users using industry standards including XML messaging facility.

12. The method of claim 7 further comprising:
providing a means for real-time collaboration between the user and the vendor;
enabling real-time collaboration using multiple channels comprising any combination of on-line video, on-line audio, text-messaging, instant messaging, e-mail, or telephone.

13. The method of claim 7 further comprising:
providing means for seamless integration to a user's existing corporate data systems.

14. A method for performing commoditizing of business service into atomic units, the method comprising:
providing a means for a user to define the business service in terms of standardized services wherein the means further includes providing a graphical user interface whereby the user selects a set of pre-identified atomic tasks from a population of a plurality of atomic tasks;
providing a means for routing a plurality of selected atomic task representing the commoditized business service to at least one vendor from a population comprising a plurality of vendors wherein the plurality of vendors are determined based on a set of selection criteria;
providing a means for re-integrating the plurality of selected atomic tasks into a final product representing the output of the commoditized business service; and
providing a platform adapted to interface with the user and the vendor and further adapted to manage the routing means.

15. The method of claim 14 further comprising:
providing a means for a process modeling tool; and
providing automated routing of the atomic unit based on results from the process modeling tool.

16. The method of claim 14 further comprising:
providing means for automated routing of the atomic unit using load availability data provided by the plurality of vendors.

17. The method of claim 14 further comprising:
providing a means for evaluating the plurality of vendors.

18. The method of claim 14 further comprising:
providing a means for enabling the user to define input parameters;
providing a means for evaluating the plurality of vendors based on the input parameters;
applying a heuristic to select a given vendor from the plurality of vendors; and
routing the atomic unit to the given vendor.

19. The method of claim 4 further comprising:
providing means to enable smart appliances to access the platform.

20. The method of claim 19 further comprising:
providing means for enabling automated interaction of the smart appliance with the platform.
